(19) United States
(12) Patent Application Publication
(10) Pub. No.: US 2025/0335185 A1
(43) Pub. Date: Oct. 30, 2025

(54) AUTOMATED CODE REVIEW USING ARTIFICIAL INTELLIGENCE

(71) Applicant: Capital One Services, LLC, McLean, VA (US)

(72) Inventor: Taylor TURNER, Richmond, VA (US)

(21) Appl. No.: 18/648,080

(22) Filed: Apr. 26, 2024

(51) Int. Cl. G06F 8/71; G06F 8/75; G06F 11/36

(52) U.S. Cl. CPC G06F 8/71; G06F 8/75; G06F 11/3608

(57) ABSTRACT

In some implementations, a device may obtain an indication of a proposed change to a subset of executable code from a set of executable code. The device may determine, via one or more models, first context information associated with the proposed change and second context information associated with at least one of the subset of executable code, the set of executable code, or a context of the subset of executable code within the set of executable code. The device may determine a scrutiny level for review of the proposed change based on at least one of the first context information or the second context information. The device may obtain, via the one or more models, review information associated with the proposed change, wherein the one or more models apply the scrutiny level to obtain the review information. The device may perform an action based on the review information.

### BACKGROUND

A code repository, also referred to as a version control system (VCS), may be associated with a software tool that manages changes to code over time. A code repository may be used in product development to keep track of changes made to a codebase, to collaborate between developers, and/or to ensure that different versions of the code are properly maintained, among other examples. A code repository may be a centralized code repository (e.g., where all code is stored on a central server, and developers must connect to the server to access the code) or a distributed code repository (e.g., where each developer has their own copy of the code, and changes can be synchronized between copies). A system associated with a code repository may provide features, such as version control, branching, merging, and/or issue tracking, which make it easier for developers to collaborate and maintain high-quality codebases.

### SUMMARY

Some implementations described herein relate to a system for automated code review using artificial intelligence (AI). The system may include one or more memories and one or more processors communicatively coupled to the one or more memories. The one or more processors may be configured to obtain a pull request indicating a proposed change to a subset of executable code from a set of executable code. The one or more processors may be configured to determine, using one or more AI models, first context information associated with the proposed change and second context information associated with at least one of the subset of executable code, the set of executable code, or a context of the subset of executable code within the set of executable code. The one or more processors may be configured to generate an embedding vector representing at least one of the first context information or the second context information. The one or more processors may be configured to determine, using the embedding vector and an embedding space, a scrutiny level for review of the pull request based on at least one of the first context information or the second context information. The one or more processors may be configured to obtain, via the one or more AI models and using the scrutiny level, review information associated with the pull request. The one or more processors may be configured to perform, based on the review information, an action to modify the proposed change or to commit the proposed change to the set of executable code.

Some implementations described herein relate to a method for automated code review. The method may include obtaining, by a device, an indication of a proposed change to a subset of executable code from a set of executable code. The method may include determining, by the device and via one or more models, first context information associated with the proposed change and second context information associated with at least one of the subset of executable code, the set of executable code, or a context of the subset of executable code within the set of executable code. The method may include determining, by the device, a scrutiny level for review of the proposed change based on at least one of the first context information or the second context information. The method may include obtaining, by the device and via the one or more models, review information associated with the proposed change, wherein the one or more models apply the scrutiny level to obtain the review information. The method may include performing, by the device, an action based on the review information.

Some implementations described herein relate to a non-transitory computer-readable medium that stores a set of instructions. The set of instructions, when executed by one or more processors of a device, may cause the device to obtain a pull request indicating a proposed change to a subset of executable code from a set of executable code. The set of instructions, when executed by one or more processors of the device, may cause the device to determine, using one or more AI models, first context information associated with the proposed change and second context information associated with at least one of the subset of executable code, the set of executable code, or a context of the subset of executable code within the set of executable code. The set of instructions, when executed by one or more processors of the device, may cause the device to determine a scrutiny level for review of the pull request based on at least one of the first context information or the second context information. The set of instructions, when executed by one or more processors of the device, may cause the device to obtain, via the one or more AI models and using the scrutiny level, review information associated with the pull request. The set of instructions, when executed by one or more processors of the device, may cause the device to provide, for display or output, the review information.

### BRIEF DESCRIPTION OF THE DRAWINGS

FIGS. 1A-1C are diagrams of an example associated with automated code review using AI, in accordance with some embodiments of the present disclosure.

FIG. 2 is a diagram of an example environment in which systems and/or methods described herein may be implemented, in accordance with some embodiments of the present disclosure.

FIG. 3 is a diagram of example components of a device associated with automated code review using AI, in accordance with some embodiments of the present disclosure.

FIG. 4 is a flowchart of an example process associated with automated code review using AI, in accordance with some embodiments of the present disclosure.

### DETAILED DESCRIPTION

The following detailed description of example implementations refers to the accompanying drawings. The same reference numbers in different drawings may identify the same or similar elements.

When a software developer or development team modifies or changes software, even a small change can have unexpected consequences. Accordingly, before deploying an impending code change to modify existing code in a code base and/or add new code to the code base, developers and quality assurance (QA) personnel typically subject the impending code change to regression testing to verify that the impending code change does not break any existing functionality. Many software projects are developed by a team, where a developer may store at least some files locally, and the developer may update the code in those locally stored files (e.g., for debugging, to add new features, and so on). The developer may then input a change request to commit the locally stored files to a code repository. Some code repositories then automatically generate a pull request based on one or more changes to the software code resulting from the commit. The developer usually needs to confirm the results of the pull request before the commit is completed.

For example, the developer may perform one or more changes to a subset of code in a separate branch of the codebase (e.g., separate from a main branch of the codebase). The developer may then create a pull request to merge the one or more changes into the main branch of the codebase. The pull request may be assigned to one or more reviewers. The one or more reviewers may be other developers or team leaders. The one or more reviewers may review the one or more changes for potential issues, such as bugs, inefficiencies, adherence to coding standards, and/or maintainability, among other examples. The one or more reviewers may execute the separate branch of the codebase (e.g., with the one or more changes) to test the functionality and to ensure that the one or more changes integrate with the existing codebase. After all concerns have been addressed and the code meets the required standards, the one or more reviewers approve the pull request. After approval, the pull request may be ready to be merged into the main branch. The developer who initiated the pull request may merge the one or more changes into the main branch of the codebase.

Manual code review by human reviewers presents several challenges within the software development process. One challenge is the inherent subjectivity that reviewers bring to the process, resulting in inconsistent evaluations of code quality and adherence to coding standards. This may result in changes to code being implemented and/or executed that result in suboptimal performance of one or more functions caused by the execution of the code. Additionally, manual code review can be time-consuming, especially for extensive or complex changes, as reviewers must meticulously examine each line of code, comprehend the purpose, and assess the impact on the overall system. Moreover, reviewers may experience fatigue or diminished attention spans during lengthy review sessions, increasing the likelihood of overlooking errors or inconsistencies. Knowledge gaps among reviewers regarding certain aspects of the codebase or technologies being used may lead to missed opportunities for improvement or inaccuracies in assessing code quality. Communication challenges can also arise, as reviewers and developers may struggle to effectively convey feedback or address concerns, resulting in changes to code being implemented and/or executed that result in suboptimal performance of one or more functions caused by the execution of the code. Furthermore, manual review processes may struggle to scale effectively as codebases expand and development teams grow, resulting in bottlenecks and delays.

Further, it may be difficult to determine a level of review needed for a change to code (e.g., for a pull request). For example, a reviewer may examine one or more changes to code and determine an amount of time to dedicate to reviewing the one or more changes (e.g., based on the quantity of changes and/or the extensiveness of the one or more changes). However, it may be difficult for a reviewer to correctly determine the level of review. For example, a change to code may appear minor, but may impact other code that is dependent on a portion of the code being changed. As a result, the reviewer may not dedicate a sufficient amount of time to reviewing the code, increasing the likelihood of issues or errors in approved or merged code. This may result in code being executed that causes one or more issues, thereby consuming processing resources, network resources, and/or memory resources, among other examples, associated with executing the code, identifying the issues, generating one or more code changes to remedy the issues, reviewing the code changes that remedy the issues, and/or merging or deploying the one or more code changes that remedy the issues, among other examples. As another example, a reviewer may consume significant processing resources, network resources, and/or memory resources, among other examples, reviewing one or more changes to code at a higher level of review than necessary (e.g., spending additional time reviewing the code, executing the code multiple times to test functionality, or performing other review or testing functions).

Some implementations described herein enable automated code review. In some implementations, the automated code review may be performed via one or more artificial intelligence (AI) models (and/or one or more machine learning models). For example, a review device may obtain a pull request indicating a proposed change to a subset of executable code from a set of executable code (e.g., the set of executable code may be a codebase). The review device may use one or more AI models to determine a context of the proposed change within the context of a larger codebase and/or within one or more functions associated with the larger codebase. The review device may cause an AI model to review the proposed change using a scrutiny level that is based on the context. For example, the review device may modify or instruct the AI model to review the proposed change using the scrutiny level. The review device may perform one or more actions to modify the proposed change or to commit or merge the proposed change to the set of executable code (e.g., the codebase).

The review device may determine context information associated with the proposed change. For example, the review device may determine first context information associated with the proposed change. The first context information may indicate what is being changed, an impact of the change, and/or other context of the proposed change. The review device may determine second context information associated with the set of executable code and/or a context of the subset of executable code within the set of executable code. For example, the second context information may indicate a purpose or function(s) of the set of executable code, a purpose or function(s) of the subset of executable code (e.g., within the context of the set of executable code), and/or other context information. In some implementations, the review device may determine a scrutiny level for review of the pull request based on the first context information and/or the second context information.

In some implementations, the review device may generate an embedding vector representing at least one of the first context information or the second context information. The review device may place the embedding vector in an embedding space. The embedding space may include embedding vectors for respective historical changes to the set of executable code (e.g., to the codebase). The review device may determine the scrutiny level based on a location of the embedding vector in the embedding space. For example, the review device may identify a nearest neighbor embedding vector in the embedding space to the embedding vector (e.g., the nearest neighbor embedding vector may be associated with a nearest distance metric (such as Euclidean distance, cosine similarity, or another distance metric) to the embedding vector in the embedding space). The review device may determine the scrutiny level based on a scrutiny level applied for a proposed change associated with the nearest neighbor embedding vector.

As a result, an accuracy and/or efficiency of review operations for proposed changes to executable code is improved. For example, by enabling the review device to cause one or more AI models to review the proposed change using an appropriate scrutiny level, the review device may conserve processing resources, memory resources, and/or network resources that would have otherwise been used performing operations to review, execute, and/or deploy the code at an inappropriate scrutiny level. For example, by causing the one or more AI models to review the proposed change using the appropriate scrutiny level, the review device may conserve processing resources, memory resources, and/or network resources that would have otherwise been used performing operations to review, execute, and/or modify, among other examples, the proposed change with more scrutiny or detail than is needed, given the context of the proposed change. As another example, by causing the one or more AI models to review the proposed change using the appropriate scrutiny level, the review device may improve performance of an application that execute the code, reduce security risks, and/or conserve processing resources, memory resources, and/or network resources that would have otherwise been associated with deploying or merging a proposed change that was reviewed with less scrutiny than is needed given the context of the proposed change (e.g., and is therefore more likely to cause issues when executed).

Additionally, the improved review of proposed changes to executable code ensures uniformity and/or quality of codebases, documentation, and/or files for software associated with performing similar, or the same, tasks and/or functions. Ensuring uniformity and/or quality improves the reliability and/or maintainability of the codebases, documentation, and/or files (e.g., when code is uniform, it is easier to maintain and update), improves collaboration (e.g., when code is uniform, it is easier for multiple developers to work together on the same project), improves efficiency (e.g., uniform code can be written more quickly and with fewer errors because developers do not have to spend time figuring out how to structure their code or use different coding conventions), improves quality (e.g., uniform code can help ensure that the code meets high-quality standards and reduces the risk of errors and vulnerabilities that could lead to security breaches, crashes, or other problems), and/or improves scalability (e.g., uniform code can be easier to scale to larger projects or teams because it is easier to manage and understand and makes it easier to integrate new features or technologies into the codebase), among other examples.

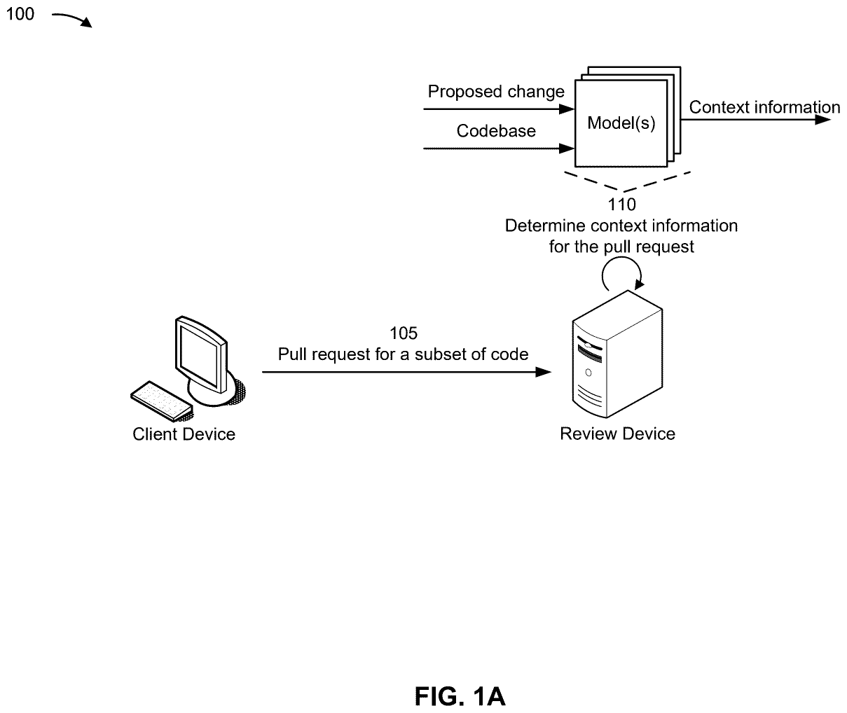

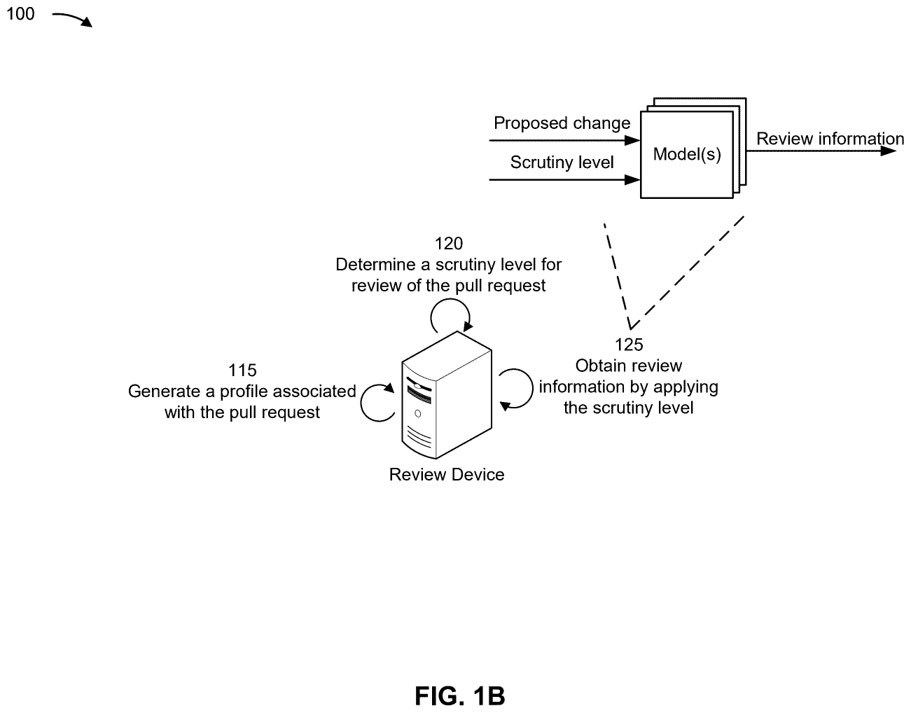

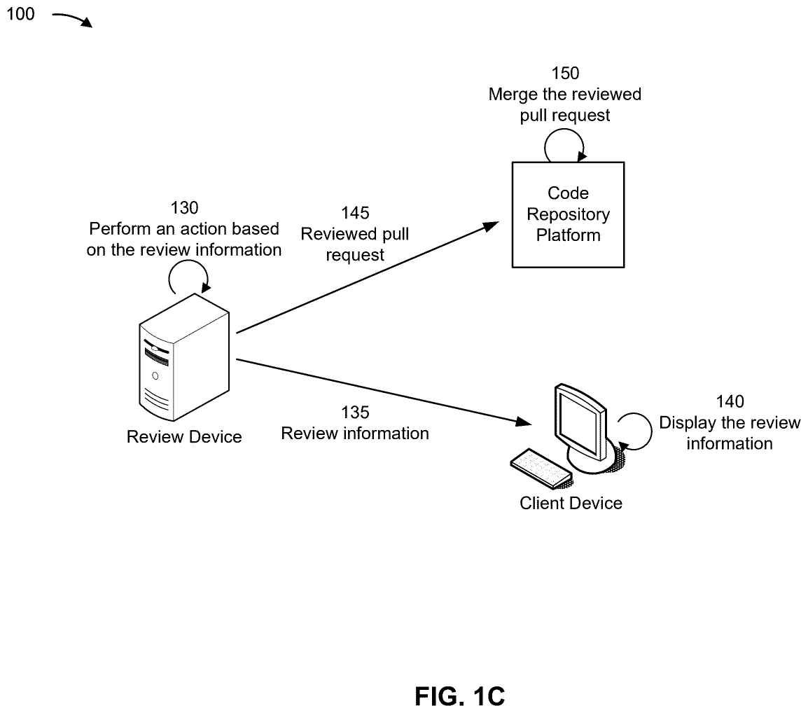

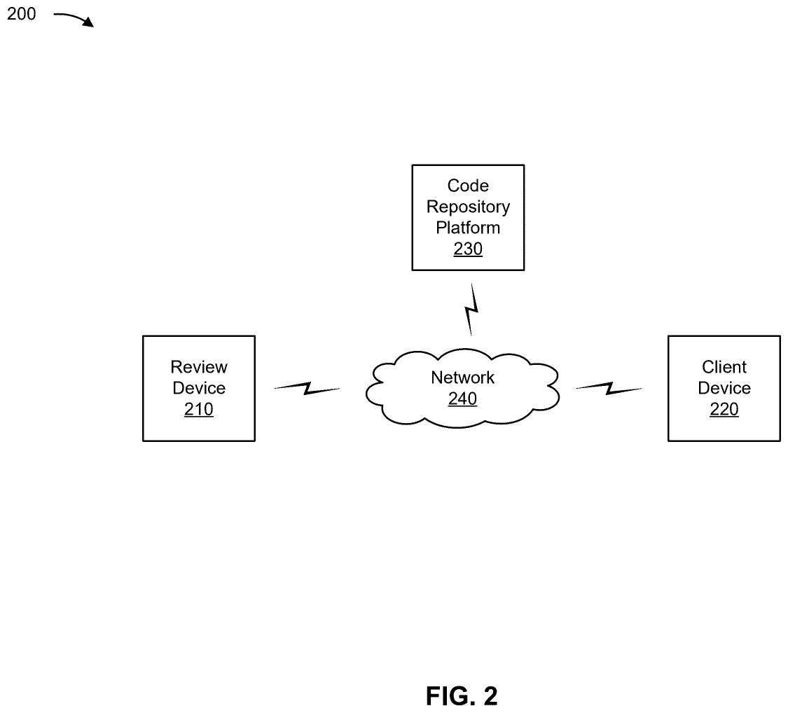

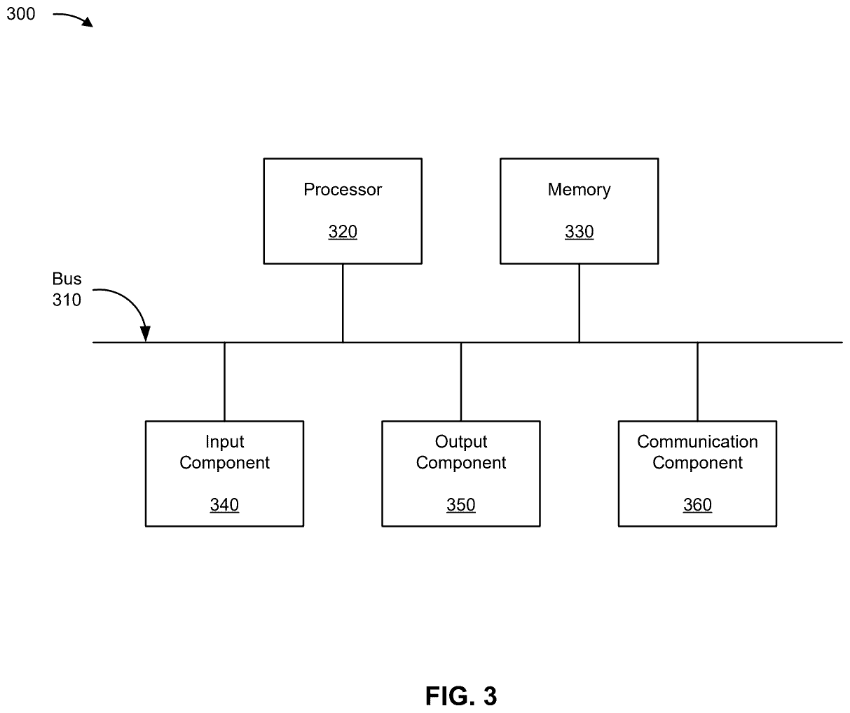

FIGS. 1A-1C are diagrams of an example 100 associated with automated code review using AI. As shown in FIGS. 1A-1C, example 100 includes a review device, a client device, and a code repository platform. These devices are described in more detail in connection with FIGS. 2 and 3. The code repository platform may include (e.g., store or host) one or more code repositories (also known as “software repositories”) of an entity. A code repository may include a set of executable code (e.g., a codebase), one or more documents, and/or one or more files, as described elsewhere herein.

As shown in FIG. 1A, and by reference number 105, the review device may obtain an indication of a proposed change to a subset of executable code from a set of executable code (e.g., a codebase). For example, the review device may obtain a pull request indicating the proposed change. A pull request may be a way for developers to propose changes to a codebase. When a pull request is created, other developers can review the changes and provide feedback. Once the changes have been approved, the changes can be merged into a main branch of the code base. In some implementations, the review device may obtain the pull request via the client device. In other implementations, the client device may provide the pull request (or create the pull request) via the code repository platform. In such examples, the review device may obtain the indication of the pull request via the code repository platform.

For example, a developer may use the client device to generate a target branch of the set of executable code. The client device may obtain an indication of one or more proposed changes that are made via the target branch. The pull request may be created to merge the target branch with the main branch of the set of executable code. The pull request may indicate a proposed set of executable code (e.g., indicating one or more changes to the subset of executable code). The pull request may include a title and/or a description summarizing or describing the purpose of the pull request, such as a rationale of the proposed change, relevant background information, and/or instructions for reviewers on how to test the proposed change, among other examples.

The pull request may include one or more proposed changes to a codebase. For example, the pull request may indicate one or more commits. A commit may indicate one or more modified files, one or more code changes, one or more commit messages, author information (e.g., information indicating an account or developer), a timestamp, and/or an identifier, among other examples. For example, the pull request may indicate one or more commits, where each commit indicates specific changes made to executable code and/or one or more files. In some implementations, the pull request may indicate one or more difference files. A difference file is sometimes referred to as a “diff.” A difference file may be a visual representation within a given file. For example, a difference file may indicate additions, modification, and/or deletions, among other examples, to a given code or to executable code.

The pull request may indicate one or more comments or discussion information to indicate information for specific aspects of the proposed change. For example, the pull request may indicate changes corresponding to specific lines of code and/or to the proposed change as a whole. In some implementations, the pull request may indicate one or more reviewers assigned to review the pull request. In some implementations, the pull request may indicate that the one or more reviewers include an automated review (or an AI-based review), as described herein. For example, the review device may perform one or more operations described herein based on, or in response to, the pull request indicating that the one or more reviewers include an automated review (or an AI-based review). The pull request may include one or more labels or assigned categories to categorize the pull request based on a status, priority, and/or type (e.g., bug fix, feature documentation, or another type of pull request), among other examples.

The review device may obtain, from the code repository platform, documents associated with the set of executable code (e.g., associated with the pull request). For example, the review device may obtain the documents based on, or in response to, detecting a trigger event and/or obtaining the pull request (e.g., the trigger event may include the pull request indicating that the review is to be an automated or AI-based review). The review device may obtain one or more documents included in a code repository associated with the pull request. For example, the review device may transmit, and the code repository platform may receive, a request for the documents associated with the set of executable code (e.g., associated with a code repository that is associated with the pull request). The code repository platform may transmit, and the review device may receive, the documents associated with the set of executable code in response to the request. In some implementations, the review device may retrieve and/or download the documents associated with a set of executable code from a memory associated with the code repository platform.

The documents associated with the set of executable code may include one or more code files, configuration files, and/or other documents associated with maintaining, supporting, and/or explaining code and/or software. For example, the documents may include a codebase, one or more code files, one or more configuration files, one or more libraries, one or more support documents (e.g., technical or user documentation that is associated with understanding and/or using the software, such as user guides, API documentation, and/or technical specifications, among other examples), source code, one or more text files, one or more license files, one or more test files, and/or one or more build files, among other examples.

As shown by reference number 110, the review device may determine context information for the pull request. As used herein, “context information” may refer to relevant details, rationale, circumstances, dependencies, and/or conditions, among other examples, surrounding a particular event, process, or data point, such as a pull request or proposed change to executable code. The context information may improve understanding of the significance, interpretation, and/or application, among other examples, of the pull request or proposed change within a given context. The context information may provide additional clarity, insight, and/or background knowledge, among other examples, that enables the review device to make informed decisions, draw accurate conclusions, and/or perform specific tasks effectively, among other examples. The context information may include factors such as environmental conditions, historical data, user preferences, system configurations, and/or other relevant contextual cues. The factors may influence the interpretation or behavior of the review performed by the review device. For example, the context information may be utilized to enhance the performance, adaptability, or relevance of algorithms, systems, or applications (such as the one or more models described herein) by incorporating contextual cues into the model(s) processes, analyses, and/or outputs. In this way, the context information may improve the performance of the one or more AI models used to review the pull request, as described in more detail herein.

For example, as shown in FIG. 1A, the review device may use one or more models to determine the context information. The one or more models may be AI models and/or machine learning models. AI includes a broad range of technologies and approaches that enable machines to mimic human intelligence and cognitive processes. For example, an AI model may be capable of learning and/or adapting from data (e.g., displaying human-like cognitive abilities). Examples of artificial intelligence techniques include machine learning, rule-based systems, deep learning models, expert systems, and/or neural networks, among other examples. Machine learning involves computers learning from data to perform tasks. Machine learning algorithms are used to train machine learning models based on sample data, known as “training data.” Once trained, machine learning models may be used to make predictions, decisions, or classifications relating to new observations.

In some implementations, the review device may use a single model to determine the context information. In other implementations, the review device may use multiple models to determine the context information. For example, the one or more models (e.g., AI models) may include a first model trained and/or configured to determine context information for a proposed change to code (e.g., context information for a pull request). The one or more models may include a second model trained and/or configured to determine context information for a codebase and/or code repository associated with the pull request. For example, the first model may be trained and/or configured to determine context information for specific changes to code, and the second model may be trained and/or configured to determine context information for a larger codebase in which the proposed change(s) will be deployed. Using separate models for different tasks provides greater flexibility, efficiency, and/or effectiveness, among other examples, in developing AI or ML based systems, such in complex and diverse problem domains. For example, each model can be optimized specifically for respective tasks. For example, the architecture, hyperparameters, and/or training data can be tailored to maximize performance for the particular task of a given model.

Additionally, using separate models may reduce the complexity of each model because the models can be simpler and/or more focused to a particular task. This may result in training and inference being more efficient and/or easier to interpret and debug. For example, a single model performing multiple tasks may become overly complex and difficult to manage. Further, by using multiple models as described above, the review device may improve resource utilization. For example, different tasks may have different computational requirements and/or memory constraints. Using separate models may enable improved resource utilization because the review device can allocate resources to each model based on specific needs of a given model. This may improve performance and/or scalability of the models, such as in resource-constrained environments.

The one or more models may be trained using historical data of the code repository (e.g., associated with the pull request) and/or other code repositories. The review device may obtain the training data from the code repository platform. The training data may include pull requests and/or code repositories with respective context information (e.g., that may be input or labeled). In some implementations, the training data may be associated with other code repositories having similar functions, purposes, and/or applications as the code repository associated with the pull request (e.g., to improve the relevancy of the training data). In some implementations, the training data may be associated with (e.g., specific to) a developer or an account that generated, initiated, and/or provided the pull request. For example, the training data may include pull requests and/or executable code with respective labeled context information, where the pull requests and/or executable code were previously generated, initiated, and/or provided by the developer or the account that generated, initiated, and/or provided the pull request.

As shown in FIG. 1A, the review device may provide one or more inputs to the model(s) to cause the model(s) to output the context information. For example, the one or more inputs may include the proposed change (e.g., the pull request) and/or the codebase (e.g., the subset of executable code and/or the set of executable code). Additionally, the one or more inputs may include information associated with the pull request, such as an author (e.g., an account and/or developer name), one or more difference files, and/or one or more comments or descriptions, among other examples. The one or more models may output the context information.

For example, the context information may include first context information associated with the proposed change and/or the pull request. The first context information may indicate a reason for the pull request, what is being changed by the pull request, an amount or level of change (e.g., an amount of code being changed) by the proposed change, an impact of the proposed change, a function or application associated with the proposed change, one or more files associated with the proposed change, and/or other context information associated with the proposed change or the pull request. The review device may obtain the first context information via a first model (e.g., a first AI model).

The context information may include second context information associated with the subset of executable code (e.g., being changed by the pull request), the set of executable code (e.g., the codebase), and/or a context of the subset of executable code within the set of executable code. For example, the second context information may provide context to the codebase as a whole. The second context information may indicate dependencies and/or interconnected components within the codebase. For example, the second context information may indicate an amount of code or files and/or which files or code is impacted by the proposed change (e.g., which files or code would be impacted if the proposed change were to be merged or deployed). Additionally, or alternatively, the second context information may indicate a purpose or function of the codebase and/or the set of executable code. The second context information may indicate a context of the proposed change within a broader landscape of the full codebase.

In some implementations, as shown in FIG. 1B and by reference number 115, the review device may generate a profile associated with the pull request. The profile may be based on the first context information and/or the second context information. For example, the review device may generate, using the first context information and/or the second context information, the profile representing the proposed change. The profile may indicate one or more parameters of the proposed change and/or the pull request.

For example, the one or more parameters may include a title, a description, an impact level of the proposed change (e.g., indicating a measure of the impact of the proposed change on the codebase as a whole), a type of change being proposed, a category of change being proposed, one or more impacted files, a rationale or reason for the proposed change, one or more commits, branch information (e.g., indicating a source branch, a target branch, and/or a main branch associated with the pull request), one or more associated issues or tickets (e.g., indicating related or known issues being addressed by the pull request), one or more reviewer assignments, one or more labels or tags, timeline information, continuous integration (CI) and continuous deployment (CD) pipeline status (e.g., build and test results, code quality metric(s), and/or deployment status), among other examples.

As shown by reference number 120, the review device may determine a scrutiny level for review of the pull request. The scrutiny level may indicate a level of detail and/or level of rigor to be applied by a model (e.g., an AI model) reviewing the proposed change and/or the pull request. For example, the scrutiny level may indicate (e.g., implicitly) an amount of computational or processing resources to be applied or used by the model when reviewing the pull request. In some implementations, the scrutiny level may be a hyperparameter of the model (e.g., the AI model) used to review the pull request. For example, the review device may set a value of a hyperparameter of the model based on the determined scrutiny level. This may cause the model to review the pull request using the determined scrutiny level.

As another example, the scrutiny level may be a setting of the model (e.g., the AI model) used to review the pull request. For example, the model may be trained to review pull requests at different levels of scrutiny (e.g., a low level of scrutiny, a medium level of scrutiny, and/or a high level of scrutiny, among other examples). The review device may set the level of scrutiny to the determined level of scrutiny. Additionally, or alternatively, the scrutiny level may be a prompt input that is provided to the model (e.g., the AI model) used to review the pull request.

In some implementations, the review device may determine the level of scrutiny based on the first context information and/or the second context information. For example, if the context information (e.g., the first context information and/or the second context information) indicates a proposed change having a large impact to the codebase and/or functionality (e.g., a proposed change that modifies a variable or aspect of the code that will impact a large quantity of other parts of the code), then the review device may determine a higher level of scrutiny is to be applied. As another example, if the context information (e.g., the first context information and/or the second context information) indicates a proposed change having a small impact to the codebase and/or functionality, then the review device may determine a lower level of scrutiny is to be applied. For example, the context information (e.g., the first context information and/or the second context information) may indicate a risk score associated with the proposed change. The risk score may indicate a likelihood that the proposed change will cause issues (e.g., bugs, inefficiencies, lack of adherence to coding standards, and/or maintainability). For example, the review device may determine the risk score based on the context information (e.g., the first context information and/or the second context information). The review device may determine the scrutiny level based on the risk score. For example, the review device may determine whether the risk score satisfies one or more thresholds. The review device may determine the scrutiny level based on whether the risk score satisfies the one or more thresholds (and/or which thresholds the risk score satisfies). For example, if the risk score satisfies a first threshold and does not satisfy a second threshold, then the review device may determine that the scrutiny level is a first scrutiny level. If the risk score satisfies the first threshold and the second threshold, then the review device may determine that the scrutiny level is a second scrutiny level.

In some implementations, the review device may generate an embedding vector representing the first context information and/or the second context information. For example, the review device may generate one or more embeddings for one or more respective information or data points indicated by the first context information and/or the second context information. An embedding (also referred to as an embedding vector) may be a mapping of a discrete (e.g., categorical) variable to a vector (e.g., an embedding vector) of numbers (e.g., continuous numbers). For example, embeddings may be low dimensional, learned continuous vector representations of discrete variables. In other words, embeddings are numerical representations of objects, such as words or images, that are learned by deep learning algorithms from large amounts of data. The embeddings may be high-dimensional, meaning they consist of a large number of features. For example, a model may generate word embeddings (e.g., that enable words with similar meanings to have a similar representation in an embedding space). For example, word embeddings may enable individual words to be represented as real-valued vectors in a predefined embedding space. Each word or phrase (e.g., a set of words) may be mapped to one embedding vector, and the embedding vector values may be learned in a way that resembles how a neural network learns.

For example, the review device may generate one or more embedding vectors using a machine learning model. The machine learning model may be trained to generate a numerical representation of context information that captures the context information's meaning and context. The machine learning model may be any machine learning model configured to generate embeddings or embedding vectors for information (e.g., code functions, characters, strings of characters, a profile of context information, portions of a file, or other portions of a document) described herein. For example, the machine learning model may include a bidirectional encoder representations from transformers (BERT) model, a Word2vec model, a global vectors for word representation (GloVe) model, a residual network (ResNet) model, and/or an autoencoder model, among other examples.

In some implementations, the review device may generate the one or more embeddings by tokenizing the context information into individual images, words, phrases, and/or sub-words. Each token may be assigned an embedding vector by providing the token to the machine learning algorithm (e.g., where the output of the machine learning algorithm is the embedding vector). The machine learning algorithm may consider the context in which each token appears in the context information, as well as the contexts of neighboring tokens, to generate a contextual embedding for each token.

In some implementations, the review device may aggregate the resulting embeddings for all of the tokens in the context information to generate a single embedding vector that represents the context information. The review device may aggregate the embeddings by taking the mean or max of the token embeddings and/or by using attention mechanisms to give more weight to certain tokens or to specific parts of the context information. By capturing the meaning and context of the context information in a numerical representation, the (one or more) embedding vectors enable machine learning models and/or the review device to understand and process the context of a pull request more effectively.

In some implementations, the review device may plot the embedding vector(s) of the context information in a graph (e.g., in an embedding space). The graph may be referred to as an embedding graph or an embedding space. An embedding graph may be a graph representation of high-dimensional vectors. An embedding graph may represent high-dimensional embeddings in a lower-dimensional space, such as in two or three dimensions, using techniques such as principal component analysis (PCA) or t-distributed stochastic neighbor embedding (t-SNE), among other examples. For example, the review device may generate an embedding graph indicating one or more embeddings for context information of different pull requests. By analyzing the embedding vectors in a lower-dimensional space, the review device may gain insights into the relationships between the context information that the embedding vectors represent.

Additionally, or alternatively, the review device may generate and/or plot an embedding vector representing the profile of the context information. Using the profile to determine the scrutiny level may reduce the complexity and/or may conserve processing resources and/or computing resources because the profile may capture the context information in more succinct and/or summarized information (e.g., using the one or more parameters described above).

The review device may determine the scrutiny level based on a location of the embedding vector(s) in the embedding space. For example, different areas of the embedding space may be associated with different scrutiny levels. The review device may use one or more clustering techniques to determine which areas of the embedding space are associated with which scrutiny levels. Additionally, or alternatively, the review device may determine the scrutiny level based on a nearest neighbor embedding vector in the embedding space. For example, the review device may use a distance metric to determine the nearest neighbor embedding vector to the embedding vector(s) in the embedding space. The distance metric may be Euclidean distance, cosine similarity, or another distance metric. The review device may determine a scrutiny level that was applied for the nearest neighbor embedding vector. The review device may determine the scrutiny level for reviewing the pull request based on the scrutiny level that was applied for the nearest neighbor embedding vector. For example, the review device may determine that the scrutiny level for reviewing the pull request is the scrutiny level that was applied for the nearest neighbor embedding vector.

As shown by reference number 125, the review device may obtain review information (e.g., for the pull request) by applying the scrutiny level. For example, the review device may cause a model (e.g., an AI model) to apply or use the scrutiny level when reviewing the pull request. For example, the review device may adjust a hyperparameter, set a value of a setting, and/or provide a prompt, among other examples, to cause the model to apply or use the scrutiny level when reviewing the pull request. In some implementations, the model that reviews the pull request may be a large language model that is trained or configured to recognize and/or understand natural language text and executable code.

In some implementations, the model (e.g., the AI model) used to review the pull request may be associated with a developer and/or account that is associated with the pull request. For example, the model may be trained using account information of the account that is associated with the proposed change. For example, by training the model using historical changes and/or pull requests provided by the account (e.g., by the developer), the model may be trained to more accurately and/or efficiently review pull requests provided by the account.

For example, as shown in FIG. 1B, the scrutiny level and the proposed change may be provided as inputs to the model. Additionally, information associated with the pull request and/or the set of executable code (e.g., the codebase), such as one or more documents associated with the set of executable code, may be provided as an input to the model. In some implementations, the first context information and/or the second context information may be provided as an input to the model. The model may review and/or analyze the proposed change and/or the pull request using the scrutiny level. For example, the model may use an amount of processing resources and/or computing resources corresponding to the scrutiny level when reviewing the proposed change and/or the pull request. By using the determined scrutiny level, performance of the review device (or another device that hosts or executes the model) may be improved because the model may use an appropriate amount of processing resources and/or computing resources when reviewing the proposed change and/or the pull request.

An output of the model may include review information. The review information may indicate a review or feedback for the proposed change and/or the pull request. For example, the review information may include natural language text indicating a review or feedback for the proposed change and/or the pull request. In some implementations, the review information may include one or more suggested updates or edits to the proposed change. For example, the review information may include reviewed or proposed executable code (e.g., that incorporates the one or more suggested updates or edits to the proposed change).

In some implementations, the review information may include a proposed or reviewed pull request that incorporates the one or more suggested updates or edits to the proposed change). For example, the model may generate a pull request that incorporates the one or more suggested updates or edits and includes comments or descriptions describing the one or more suggested updates or edits and/or providing a rationale for the one or more suggested updates or edits. For example, the model may determine that a modification proposed by the pull request will result in one or more issues for the codebase, such as for another subset of executable code that references a variable or file modified by the pull request. The review information may suggest that the modification not be made and/or may propose another modification that mitigates the one or more issues for the codebase.

As shown in FIG. 1C, and by reference number 130, the review device may perform one or more actions based on the review information. For example, as shown by reference number 135, the review device may provide, for display or output, the review information. For example, as shown by reference number 140, the client device may display or output the review information. For example, the review information may be integrated in a user interface that is provided by the code repository platform. The review device may cause the user interface to be modified and/or may insert the review information to cause the client device to display the review information via the user interface.

In some implementations, as shown by reference number 145, the review device may provide, and the code repository platform may obtain, a reviewed pull request. For example, as described above, the review device and/or the model may generate a reviewed pull request indicating a reviewed change to the subset of executable code. The reviewed change may incorporate the proposed change (e.g., indicated by the pull request) and the review information. For example, the reviewed pull request may indicate a change to the subset of executable code that is based on the proposed change (e.g., indicated by the pull request) and the review information. The review device may cause the reviewed pull request to be merged or committed with the set of executable code (e.g., with the codebase and/or code repository). For example, as shown by reference number 150, the code repository platform may merge or commit the reviewed pull request.

In some implementations, the review device may control or manage a flow of traffic to an application or component that executes the set of executable code based on the review information, the first context information, and/or the second context information. For example, the review device may restrict or limit a flow of traffic (e.g., network traffic) to an application or component that executes the set of executable code if the review information, the first context information, and/or the second context information indicates that there is a higher risk of issues caused by the proposed change indicated by the pull request.

In some implementations, the review device may monitor a performance of an application or component that executes the set of executable code after the pull request or the reviewed pull request is merged into the set of executable code. For example, the review device may determine whether there are any issues in a deployed version of the set of executable code that incorporates the proposed change reviewed and/or suggested by the review device. If the review device detects one or more issues associated with the deployed version of the set of executable code, then the review device may modify and/or update one or more models described herein. For example, if the review device detects one or more issues associated with the deployed version of the set of executable code, then the review device may update one or more parameters, hyperparameters, settings, and/or algorithms, among other examples, to cause similar pull requests to be reviewed with a higher level of scrutiny or rigor in the future. For example, the review device may modify a clustering or categorization of the embedding space to cause pull requests that are similar to the pull request that caused one or more issues when deployed to be reviewed with a higher level of scrutiny or rigor in the future. Incorporating feedback from the deployed version of the executable code that includes the proposed change may improve a performance of the one or more models described herein by improving the determination of the scrutiny level to be applied when reviewing pull requests and/or proposed changes. By using a more appropriate scrutiny level, the performance of the review device (or another device that hosts or executes the model(s)) may be improved because the model(s) may use an appropriate amount of processing resources and/or computing resources when reviewing the proposed change and/or the pull request.

As indicated above, FIGS. 1A-1C are provided as an example. Other examples may differ from what is described with regard to FIGS. 1A-1C.

FIG. 2 is a diagram of an example environment 200 in which systems and/or methods described herein may be implemented. As shown in FIG. 2, environment 200 may include a review device 210, a client device 220, a code repository platform 230, and a network 240. Devices of environment 200 may interconnect via wired connections, wireless connections, or a combination of wired and wireless connections.

The review device 210 may include one or more devices capable of receiving, generating, storing, processing, providing, and/or routing information associated with automated code review using AI, as described elsewhere herein. The review device 210 may include a communication device and/or a computing device. For example, the review device 210 may include a server, such as an application server, a client server, a web server, a database server, a host server, a proxy server, a virtual server (e.g., executing on computing hardware), or a server in a cloud computing system. In some implementations, the review device 210 may include computing hardware used in a cloud computing environment.

The client device 220 may include one or more devices capable of receiving, generating, storing, processing, and/or providing information associated with automated code review using AI, as described elsewhere herein. The client device 220 may include a communication device and/or a computing device. For example, the client device 220 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The code repository platform 230 may include one or more devices capable of receiving, generating, storing, processing, providing, and/or routing information associated with automated code review using AI, as described elsewhere herein. The code repository platform 230 may include a communication device and/or a computing device. For example, the code repository platform 230 may include a server, such as an application server, a client server, a web server, a database server, a host server, a proxy server, a virtual server (e.g., executing on computing hardware), or a server in a cloud computing system. In some implementations, the code repository platform 230 may include computing hardware used in a cloud computing environment.

The network 240 may include one or more wired and/or wireless networks. For example, the network 240 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 240 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300 associated with automated code review using AI. The device 300 may correspond to the review device 210, the client device 220, and/or the code repository platform 230. In some implementations, the review device 210, the client device 220, and/or the code repository platform 230 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

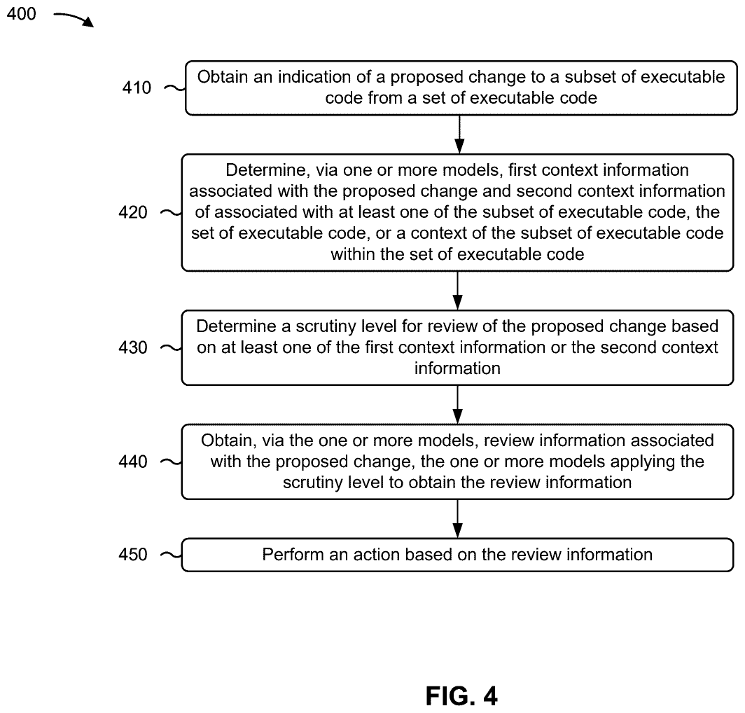

FIG. 4 is a flowchart of an example process 400 associated with automated code review using AI. In some implementations, one or more process blocks of FIG. 4 may be performed by the review device 210. In some implementations, one or more process blocks of FIG. 4 may be performed by another device or a group of devices separate from or including the review device 210, such as the client device 220 and/or the code repository platform 230. Additionally, or alternatively, one or more process blocks of FIG. 4 may be performed by one or more components of the device 300, such as processor 320, memory 330, input component 340, output component 350, and/or communication component 360.

As shown in FIG. 4, process 400 may include obtaining an indication of a proposed change to a subset of executable code from a set of executable code (block 410). For example, the review device 210 (e.g., using processor 320 and/or memory 330) may obtain an indication of a proposed change to a subset of executable code from a set of executable code, as described above in connection with reference number 105 of FIG. 1A. As an example, the review device 210 may obtain a pull request indicating the proposed change.

As further shown in FIG. 4, process 400 may include determining, via one or more models, first context information associated with the proposed change and second context information associated with at least one of the subset of executable code, the set of executable code, or a context of the subset of executable code within the set of executable code (block 420). For example, the review device 210 (e.g., using processor 320 and/or memory 330) may determine, via one or more models, first context information associated with the proposed change and second context information associated with at least one of the subset of executable code, the set of executable code, or a context of the subset of executable code within the set of executable code, as described above in connection with reference number 110 of FIG. 1A. As an example, the first context information may indicate a context of the proposed change and the second context information may indicate a context of a broader codebase as a whole (e.g., including an impact of the proposed change in the broader codebase).

As further shown in FIG. 4, process 400 may include determining a scrutiny level for review of the proposed change based on at least one of the first context information or the second context information (block 430). For example, the review device 210 (e.g., using processor 320 and/or memory 330) may determine a scrutiny level for review of the proposed change based on at least one of the first context information or the second context information, as described above in connection with reference number 120 of FIG. 1B. As an example, the review device 210 may use a location of an embedding vector (e.g., that represents the first context information and/or the second context information) in an embedding space to determine the scrutiny level. The scrutiny level may be a level of rigor or detail applied to a review of the proposed change (e.g., of the pull request) by an AI model, such as a large language model.

As further shown in FIG. 4, process 400 may include obtaining, via the one or more models, review information associated with the proposed change (block 440). For example, the review device 210 (e.g., using processor 320 and/or memory 330) may obtain, via the one or more models, review information associated with the proposed change, as described above in connection with reference number 125 of FIG. 1B. In some implementations, the one or more models apply the scrutiny level to obtain the review information. As an example, the review information may indicate feedback and/or suggested changes to the proposed change using natural language text and/or suggest executable code.

As further shown in FIG. 4, process 400 may include performing an action based on the review information (block 450). For example, the review device 210 (e.g., using processor 320 and/or memory 330) may perform an action based on the review information, as described above in connection with reference number 130, reference number 135, and/or reference number 145 of FIG. 1C. As an example, the review device 210 may cause the review information to be displayed or output. As another example, the review device 210 may perform an action to modify the proposed change or to commit the proposed change to the set of executable code.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A-1C. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for automated code review using artificial intelligence (AI), the system comprising:
one or more memories; and
one or more processors, communicatively coupled to the one or more memories, configured to:
obtain a pull request indicating a proposed change to a subset of executable code from a set of executable code;
determine, using one or more AI models, first context information associated with the proposed change and second context information associated with at least one of the subset of executable code, the set of executable code, or a context of the subset of executable code within the set of executable code;
generate an embedding vector representing at least one of the first context information or the second context information;
determine, using the embedding vector and an embedding space, a scrutiny level for review of the pull request based on at least one of the first context information or the second context information;
obtain, via the one or more AI models and using the scrutiny level, review information associated with the pull request; and
perform, based on the review information, an action to modify the proposed change or to commit the proposed change to the set of executable code.

2. The system of claim 1, wherein the review information includes at least one of:
natural language text indicating a review of the proposed change, or
proposed executable code to be included in the proposed change.

3. The system of claim 1, wherein the one or more AI models include at least one of:
a first model configured to output the first context information,
a second model configured to output the second context information, or
a third model configured to output the review information.

4. The system of claim 1, wherein the scrutiny level indicates a level of review to be applied by the one or more AI models when reviewing the pull request.

5. The system of claim 1, wherein the scrutiny level is indicated to the one or more AI models via at least one of:
a setting of the one or more AI models,
a hyperparameter of the one or more AI models, or
a prompt input to the one or more AI models.

6. The system of claim 1, wherein at least one of the first context information or the second context information indicates a level of impact of the proposed change to the set of executable code, and wherein the one or more processors, to determine the scrutiny level, are configured to:
determine the scrutiny level based on the level of impact of the proposed change to the set of executable code.

7. The system of claim 1, wherein the one or more processors are further configured to:
generate, using at least one of the first context information or the second context information, the embedding vector to represent the proposed change in context of the set of executable code; and
wherein the one or more processors, to determine the scrutiny level, are configured to:
determine the scrutiny level based on a location of the embedding vector in the embedding space.

8. The system of claim 1, wherein the one or more processors are further configured to:
generate, using at least one of the first context information or the second context information, a profile representing the proposed change, wherein the profile indicates one or more parameters of the proposed change; and
wherein the one or more processors, to determine the scrutiny level, are configured to:
determine the scrutiny level using the profile.

9. The system of claim 8, wherein the one or more processors, to determine the scrutiny level, are configured to:
generate another embedding vector that represents the profile;
identify, in the embedding space, a nearest neighbor embedding vector to the other embedding vector; and
determine the scrutiny level based on another scrutiny level that was applied for another profile that is represented by the nearest neighbor embedding vector.

10. The system of claim 1, wherein the one or more processors, to perform the action, are configured to:
generate a reviewed pull request indicating a reviewed change to the subset of executable code,
wherein the reviewed change incorporates the proposed change and the review information; and
cause the reviewed pull request to be merged with the set of executable code.

11. A method for automated code review, comprising:
obtaining, by a device, an indication of a proposed change to a subset of executable code from a set of executable code;
determining, by the device and via one or more models, first context information associated with the proposed change and second context information associated with at least one of the subset of executable code, the set of executable code, or a context of the subset of executable code within the set of executable code;
determining, by the device, a scrutiny level for review of the proposed change based on at least one of the first context information or the second context information;
obtaining, by the device and via the one or more models, review information associated with the proposed change,
wherein the one or more models apply the scrutiny level to obtain the review information; and
performing, by the device, an action based on the review information.

12. The method of claim 11, wherein the one or more models include at least one of:
a first one or more models configured to output at least one of the first context information or the second context information, or
a second model configured to output the review information.

13. The method of claim 11, wherein obtaining the review information comprises:
providing the scrutiny level as an input to the one or more models.

14. The method of claim 11, further comprising:
generating, using at least one of the first context information or the second context information, an embedding vector that represents the proposed change in context of the set of executable code; and
wherein determining the scrutiny level comprises:
determining the scrutiny level based on a location of the embedding vector in an embedding space.

15. The method of claim 11, further comprising:
generating, using at least one of the first context information or the second context information, a profile representing the proposed change, wherein the profile indicates one or more parameters of the proposed change; and
wherein determining the scrutiny level comprises:
determining the scrutiny level using the profile.

16. The method of claim 11, wherein the one or more models include a model configured to output the review information, and
wherein the model is trained using account information of an account that is associated with the proposed change.

17. The method of claim 11, wherein the one or more models include a large language model configured to generate and output the review information.

18. A non-transitory computer-readable medium storing a set of instructions, the set of instructions comprising:
one or more instructions that, when executed by one or more processors of a device, cause the device to:
obtain a pull request indicating a proposed change to a subset of executable code from a set of executable code;
determine, using one or more artificial intelligence (AI) models, first context information associated with the proposed change and second context information associated with at least one of the subset of executable code, the set of executable code, or a context of the subset of executable code within the set of executable code;
determine a scrutiny level for review of the pull request based on at least one of the first context information or the second context information;
obtain, via the one or more AI models and using the scrutiny level, review information associated with the pull request; and
provide, for display or output, the review information.

19. The non-transitory computer-readable medium of claim 18, wherein at least one of the first context information or the second context information indicates a level of impact of the proposed change to the set of executable code, and wherein the one or more processors, to determine the scrutiny level, are configured to:
determine the scrutiny level based on the level of impact of the proposed change to the set of executable code.

20. The non-transitory computer-readable medium of claim 18, wherein the one or more instructions further cause the device to:
generate, using at least one of the first context information or the second context information, an embedding vector that represents the proposed change in context of the set of executable code; and
wherein the one or more instructions, that cause the device to determine the scrutiny level, cause the device to:
determine the scrutiny level based on a location of the embedding vector in an embedding space.
